(19) United States
(12) Patent Application Publication
(10) Pub. No.: US 2013/0021666 A1
(43) Pub. Date: Jan. 24, 2013

(54) 2D and 3D Compatible Eyeglasses and Receiving Method of the Same

(71) Applicant: Ming-Zhao Rui, Xiamen (CN)

(72) Inventor: Ming-Zhao Rui, Xiamen (CN)

(21) Appl. No.: 13/548,262

(22) Filed: Jul. 13, 2012

(30) Foreign Application Priority Data
Jul. 20, 2011 (CN) 201110204383.0

(51) Int. Cl. G02B 27/26

(52) U.S. Cl. 359/465

(57) ABSTRACT

A 2D and 3D compatible eyeglasses includes an eyeglass frame with a left polarized lens and a right polarized lens and an adjusting and receiving module mounted on the eyeglass frame and sandwiched between the left polarized lens and the right polarized lens to adjust angles of the left polarized lens and the right polarized lens so as to allow the left lens and the right lens to be at the same angle to allow the user to watch a 2D content and to allow the user to watch a 3D content when there is an angle difference between the left lens and the right lens.

### FIELD OF THE INVENTION

The invention relates to a pair of 3D and 2D compatible eyeglasses and, more particularly, to a pair of glasses capable of receiving 2D and 3D images without any change to the device. Furthermore, a 2D and 3D image receiving method is also disclosed in the invention.

### BACKGROUND OF THE INVENTION

Currently, there are two primary categories of technology for watching 3D images, namely, a pair of specially designed glasses and naked eyes. After considering the market trend and cost effectiveness, the specially designed eye glasses is much more popular than the naked eyes. The 3D image display technology primarily includes three types, i.e., anaglyphic 3D, polarization 3D and active shutter 3D. Among the three technologies, the polarization 3D and active shutter 3D are mostly adopted for their great effect.

The principle and technology involved in the 3D image display include the following understanding. At the time when the exterior display device displays an image for the left eye, the 3D eye glasses will open the left shutter and shut off the right shutter, e.g., blindfolding the audience's right eye. Then, the exterior display device displays an image for the right eye, the 3D eye glasses will open the right shutter and shut off the left shutter, e.g., blindfolding the audience's left eye. During which, the period for the left eye watching the image is defined as T left period, i.e., the timeframe for left shutter on the 3D eye glasses opens and the period for the right eye watching the image is defined as the T right period, i.e., the timeframe for right shutter on the 3D eye glasses opens. The process of switching from the left eye to the right eye is repeatedly and fast, up to 120 times per second. Therefore, it is impossible for the user to feel the difference between the switches. As a result, as long as the images for the left eye and for the right eye are correct, the user is able to see a 3D image. The switch from the left eye to the right eye and from the right eye back to the left eye is controlled by the exterior display device via sending radio synchronous controlling signal to the 3D eye glasses to complete synchrony between the 3D eye glasses and the exterior display device.

Therefore, when the user chooses 3D display mode, the display will then feed in 3D image. Users wearing 3D eyeglasses are able to see three dimensional images. However, if a user is watching the display with his/her naked eyes when the display is feeding in three dimensional images, due to the differences between the image for the left eye and image for the right eye, the user will only be able to see images with shades. That is, under the three dimensional mode, only users wearing the specially designed eyeglasses can see the three dimensional images and others without the eyeglasses cannot see a clear image with the naked eye, not even a 2D image. Furthermore, due to technology limit, if a user is watching the three dimensional content for a long period of time, the user may easily feel sick and dizzy, which will definitely influence other viewers watching the 3D content at the same time. In all, the current existing 3D display and receiving device cannot display 3D and 2D content at the same time.

### SUMMARY OF THE INVENTION

The primary objective of the present invention is to provide a pair of 3D and 2D compatible receiving glasses capable of presenting three-dimensional content and two-dimensional content at the same time.

Another objective of the present invention is to provide a method for displaying 3D and 2D images from the same display to allow users wearing the 3D eyeglasses to see three-dimensional content and to users without the specially designed eyeglasses to see regular two dimensional images simultaneously.

In order to accomplish the objectives of the present invention, the pair of receiving glasses constructed in accordance with the present invention includes an eyeglass frame, a left lens, a right lens and an adjusting and receiving module. Both the left lens and the right lens are adjustable polarized lenses controlled by the adjusting and receiving module.

The adjusting and receiving module may be a mechanically or an electrically maneuver mechanism which should be well known in the art after the description of the subject matter of the present invention.

Further, a polarized angle indicator is mounted on the eyeglass frame and controlled by the adjusting and receiving module so as to allow the user of the eyeglass to ensure the accuracy of the adjustment of the polarized angle of the lenses as well as the high quality image.

The receiving method used in the 3D and 2D compatible receiving eyeglass includes the steps of: sending out a command by the adjusting and receiving module; adjusting lens angles to allow user to see three-dimensional content when the two lenses are not in the same polarized angle and to see two-dimensional content when the two lenses are in the same polarized angles. It is to be noted that the polarized angle θ is 0°<θ<90°.

There are four different receiving mode involved in the present invention, which are:

Receiving Mode 1—3D Mode:

The angle of the left lens is θ+90° and the angle for the right lens is θ. Under such a situation, a user wearing the eyeglass of the present invention in association with exterior display is able to see a three-dimensional content.

Receiving Mode 2—3D Mode:

The angle of the left lens is θ and the angle for the right lens is θ+90°. Under such a situation, it is known that the angle for the left lens is actually the angle for the right lens in the first mode and the angle for the right lens is actually the angle for the left lens. That is, in this situation, the angles for the left lens and the right lens are switched when compared with the first mode.

Receiving Mode 3—2D Mode:

The angle for the left lens is maintained at θ and the angle for the right lens is also maintained at θ. It is noted that the angles for the left lens and the right lens are adjusted to be the same as that of the right lens in the first mode. Thus both left eye and right eye receive the same image as the image received by the right eye in the first mode. Since there is no angle difference between the left eye and the right eye, a two dimensional image is received by both eyes.

Receiving Mode 4:—2D Mode

The angle for the left lens is maintained at 90°+θ and the angle for the right lens is also maintained at 90°+θ. It is noted that the angles for the left lens and the right lens are adjusted to be the same as that of the left lens in the first mode. Thus both left eye and right eye receive the same image as the image received by the left eye in the first mode. Since there is no angle difference between the left eye and the right eye, a two dimensional image is received by both eyes.

It is noted that the eyeglass of the present invention is not only suitable in the linear polarization system, it is also suitable in circular polarized system by adding a phase difference film.

As noted from the above description, there are four different receiving modes for selection by the user. That is, if the user wants to watch a 3D image, the user may choose receiving modes 1 or 2 and if the user wants to watch a 2D image, the user may choose receiving modes 3 or 4. Under the same display without any change to the currently existing device, the user may watch 3D or 2D image by just adjusting the angles of the lenses of the eyeglass of the present invention.

### BRIEF DESCRIPTION OF THE DRAWINGS

FIG. 1 is a perspective view of the eyeglass of the present invention;

FIG. 2 is a schematic view showing the polarized angles for both lenses in the first receiving mode;

FIG. 3 is a schematic view showing the polarized angles for both lenses in the second receiving mode;

FIG. 4 is a schematic view showing the polarized angles for both lenses in the third receiving mode; and

FIG. 5 is a schematic view showing the polarized angles for both lenses in the fourth receiving mode.

### DETAILED DESCRIPTION OF THE INVENTION

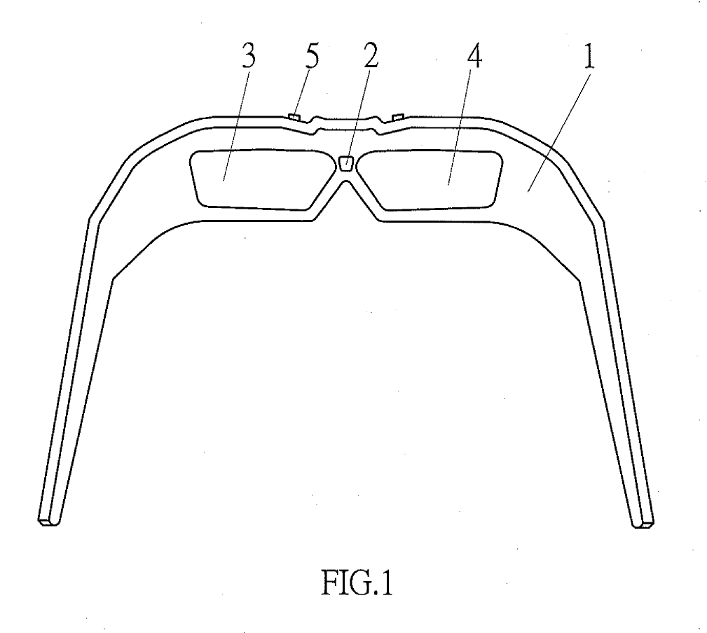

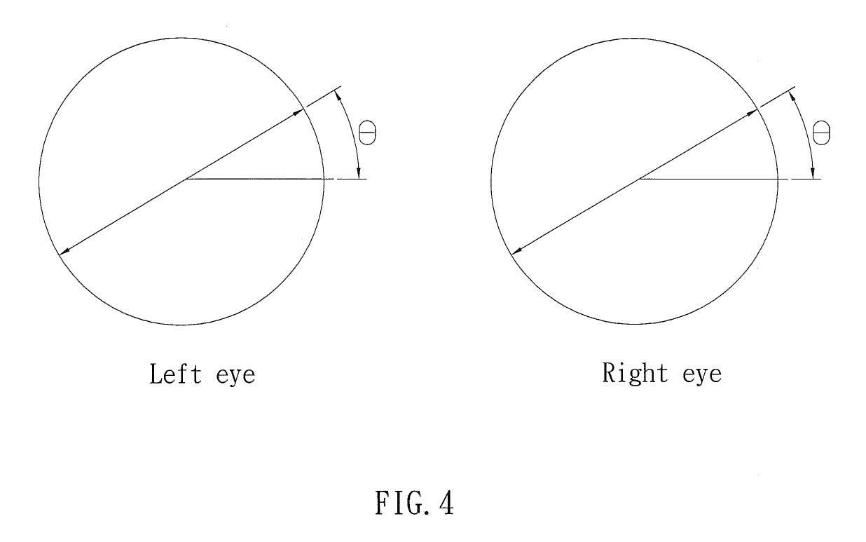

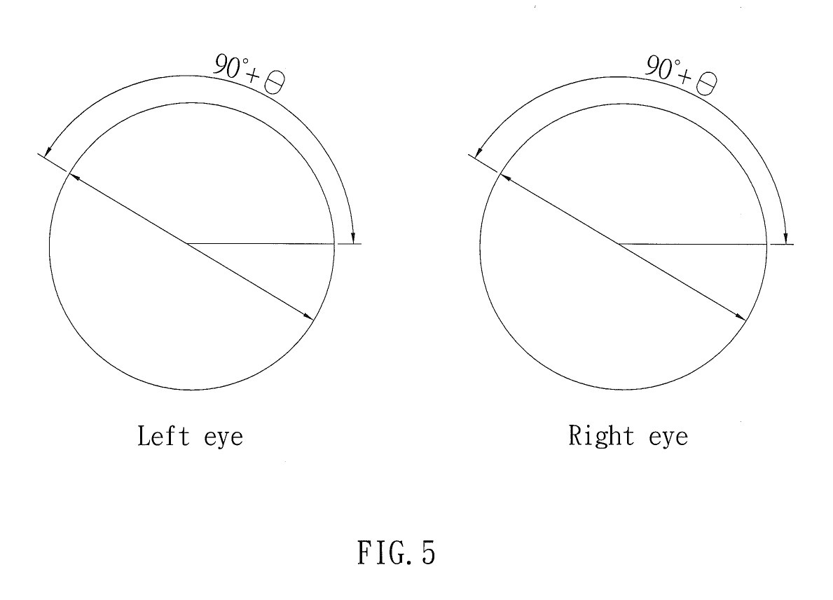

As shown in FIGS. 1-5, the receiving eyeglass constructed in accordance with the present invention includes an eyeglass frame 1, a left lens 3, a right lens 4 both of which are mounted on the eyeglass frame 1 and an adjusting and receiving module 2 also mounted on the eyeglass frame 1 and substantially sandwiched between the left lens 3 and the right lens 4. Both the left lens 3 and the right lens 4 are adjustable polarized lenses controlled by the adjusting and receiving module 2.

The adjusting and receiving module 2 may be a mechanically or an electrically maneuver mechanism which should be well known to the person skilled in the art after the description of the subject matter of the present invention.

Further, a polarized angle indicator 5 is mounted on the eyeglass frame 1 and controlled by the adjusting and receiving module 2 so as to allow the user to ensure the accuracy of the adjustment of the polarized angle of the lenses as well as the high quality image.

The receiving method used in the 3D and 2D compatible receiving eyeglass includes the steps of: sending out a command by the adjusting and receiving module 2; adjusting lens 3, 4 angles to allow user to see three-dimensional content when the two lenses 3, 4 are not in the same polarized angle and to see two-dimensional content when the two lenses 3, 4 are in the same polarized angles. It is to be noted that the polarized angle θ is 0°<θ<90°. When the two lenses 3, 4 are not in the same polarized angles, there is an angle difference between the two lenses 3, 4, 90°. That is, if the left lens 3 is in the polarized angle θ, then the polarized angle for the right lens 4 is 90°+θ, and vice versa.

There are four different receiving mode involved in the present invention, which are:

Receiving Mode 1—3D Mode:

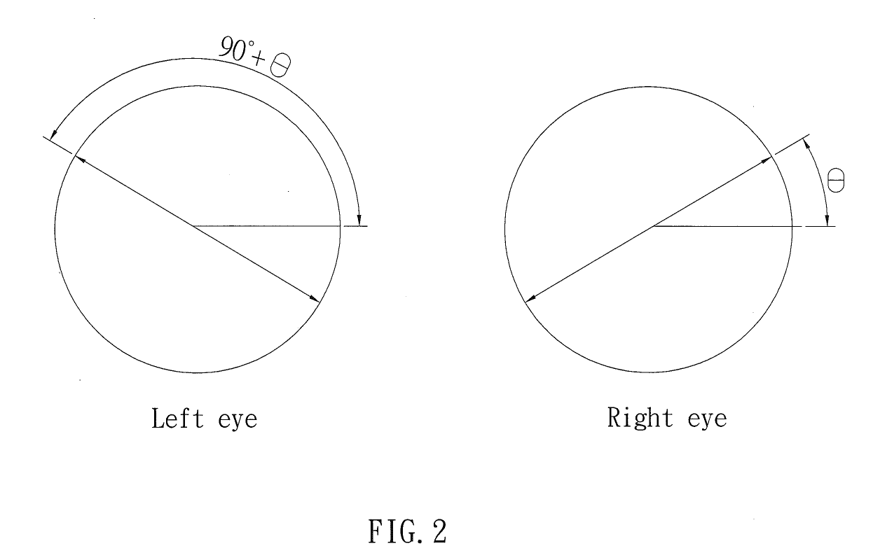

As shown in FIG. 2, the angle of the left lens 3 is θ+90° and the angle for the right lens 4 is θ. Under such a situation, a user wearing the eyeglass of the present invention in association with exterior display is able to see a three-dimensional content.

Receiving Mode 2—3D Mode:

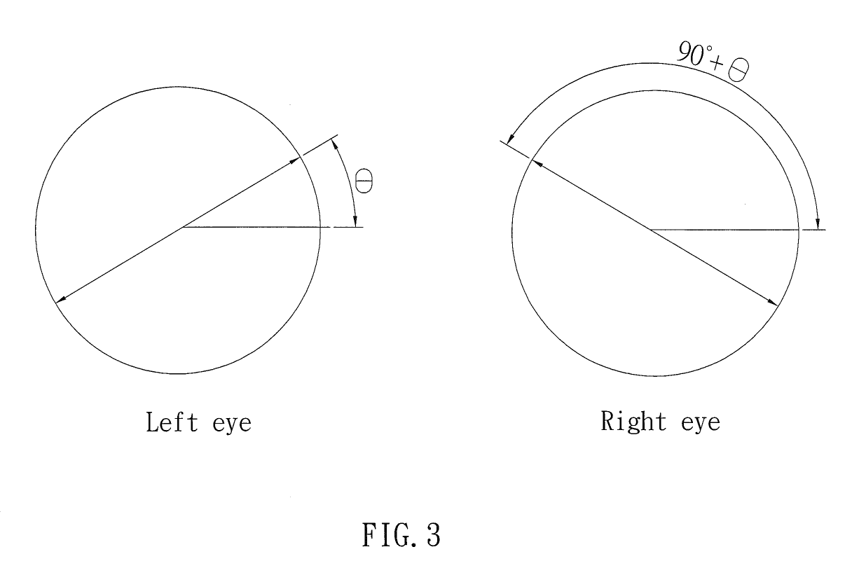

With reference to FIG. 3, the angle of the left lens 3 is θ and the angle for the right lens 4 is θ+90°. Under such a situation, it is known that the angle for the left lens 3 is actually the angle for the right lens 4 in the first mode and the angle for the right lens 4 is actually the angle for the left lens 3. That is, in this situation, the angles for the left lens 3 and the right lens 4 are switched when compared with the first mode.

Receiving Mode 3—2D Mode:

The angle for the left lens 3 is maintained at θ and the angle for the right lens 4 is also maintained at θ. It is noted that the angles for the left lens 3 and the right lens 4 are adjusted to be the same as that of the right lens 4 in the first mode. Thus both left eye and right eye receive the same image as the image received by the right eye in the first mode. Since there is no angle difference between the left eye and the right eye, a two dimensional image is received by both eyes.

Receiving Mode 4:—2D Mode

The angle for the left lens 3 is maintained at 90°+θ and the angle for the right lens 4 is also maintained at 90°+θ. It is noted that the angles for the left lens 3 and the right lens 4 are adjusted to be the same as that of the left lens 3 in the first mode. Thus both left eye and right eye receive the same image as the image received by the left eye in the first mode. Since there is no angle difference between the left eye and the right eye, a two dimensional image is received by both eyes.

It is noted that the eyeglass of the present invention is not only suitable in the linear polarization system; it is also suitable in circular polarized system by adding a phase difference film. When the lenses 3, 4 are used in the linear polarization system, the polarized angles of the lenses 3, 4 are adjusted by rotating the lenses 3, 4 or by replacing them with polarized lenses. When the lenses 3, 4 are used in the circular polarized system, because the polarization of the lenses 3, 4 in the circular polarization is caused by the adding of the phase difference film as well as the polarized lenses, if the phase difference film is affixed onto the lenses 3, 4, the polarized angle adjustment can only be finished by replacing the polarized lenses. If the phase difference film is separable from the lenses 3, 4, the polarized angle adjustment can be finished by adjusting the polarization angle of the lenses while maintaining the phase difference film unchanged.

There are thus four different receiving modes involved in the present invention. When the user wishes to receive a three dimensional content, the user may choose receiving mode 1 or 2. And when the user wishes to receive a two dimensional content, the user may choose receiving mode 3 or 4. As a result, the user may select whatever receiving mode he/she wishes to receive using the same display.

Without any change to the exterior display, the user may select a 2D or 3D content using the eyeglass of the present invention. Meantime, users using the same display may watch a 2D or 3D content simultaneously without any change to the exterior display.

It is to be noted that although the preferred embodiment of the present invention has been described, other modifications, alterations or minor change to the structure should still be within the scope defined in the claims. As those skilled in the art will readily observe that numerous modifications and alterations of the device and method may be made while retaining the teachings of the invention.

What is claimed is:

1. A 2D and 3D compatible eyeglasses consisting essentially of:
an eyeglass frame with a left polarized lens and a right polarized lens; and
an adjusting and receiving module mounted on the eyeglass frame and sandwiched between the left polarized lens and the right polarized lens to adjust angles of the left polarized lens and the right polarized lens.

2. The eyeglasses as claimed in claim 1, wherein the adjusting and receiving module is a mechanically or electrically maneuver mechanism to alter polarized angles of the left polarized lens and the right polarized lens respectively.

3. The eyeglasses as claimed in claim 1 further comprising a polarized angle indicator mounted on the eyeglass frame and controlled by the adjusting and receiving module to display angles of the left polarized angle and the right polarized angle respectively.

4. An adjusting method for use with the 2D and 3D compatible eyeglasses as claimed in claim 1, the method comprising the steps of:
sending out a command by the adjusting and receiving module; and
adjusting lens angles in response to the command from the adjusting and receiving module for a user to see three-dimensional content when the two lenses are not in the same polarized angle and see two-dimensional content when the two lenses are in the same polarized angles.

5. The method as claimed in claim 4, wherein the polarized angle θ is 0°<θ<90°.

6. The method as claimed in claim 4 consisting essentially of four receiving modes:
Receiving mode 1—3D mode:
an angle of the left polarized lens is θ+90° and the angle for the right polarized lens is θ;
Receiving mode 2—3D mode:
the angle of the left polarized lens is θ and the angle for the right polarized lens is θ+90°;
receiving mode 3—2D mode:
the angle for the left polarized lens is maintained at θ and the angle for the right polarized lens is maintained at θ;
receiving mode 4:—2D mode
the angle for the left polarized lens is maintained at 90°+θ and the angle for the right polarized lens is also maintained at 90°+θ.

7. The method as claimed in claim 5 consisting essentially of four receiving modes:
receiving mode 1—3D mode:
an angle of the left polarized lens is θ+90° and the angle for the right polarized lens is θ;
receiving mode 2—3D mode:
the angle of the left polarized lens is θ and the angle for the right polarized lens is θ+90°;
receiving mode 3—2D mode:
the angle for the left polarized lens is maintained at θ and the angle for the right polarized lens is maintained at θ;
receiving mode 4:—2D mode
the angle for the left polarized lens is maintained at 90°+θ and the angle for the right polarized lens is also maintained at 90°+θ.
